(19) United States
(12) Patent Application Publication
(10) Pub. No.: US 2008/0254323 A1
(43) Pub. Date: Oct. 16, 2008

(54) MAGNETIC RECORDING MEDIUM

(75) Inventors: Masao NAKAYAMA, Tokyo (JP); Hiromichi KANAZAWA, Tokyo (JP); Shigeharu WATASE, Tokyo (JP); Takahiro HAYASHI, Tokyo (JP)

Correspondence Address: GREENBLUM & BERNSTEIN, P.L.C., 1950 ROLAND CLARKE PLACE, RESTON, VA, 20191, US

(73) Assignee: TDK CORPORATION, Tokyo (JP)

(21) Appl. No.: 11/851,469

(22) Filed: Sep. 7, 2007

(30) Foreign Application Priority Data
Sep. 8, 2006 (JP) 2006-243492

(51) Int. Cl. G11B 5/62

(52) U.S. Cl. 428/827; 428/836.1

(57) ABSTRACT

A magnetic recording medium includes a metal thin-film magnetic layer formed on a non-magnetic substrate. The metal thin-film magnetic layer is formed so that the coercivity measured when a magnetic field is applied with an angle of intersection of 120° between the plane of the non-magnetic substrate and magnetic field lines of the magnetic field and the coercivity measured when the magnetic field is applied with the angle of intersection of 60° are both at least 160 kA/m.

### BACKGROUND OF THE INVENTION

1. Field of the Invention

The present invention relates to a magnetic recording medium where a metal thin-film magnetic layer is formed on a non-magnetic substrate.

2. Description of the Related Art

Due to the increasing size of recorded data, it is necessary to increase the recording density of current information media. Many magnetic tapes marketed as backup media are so-called “wet-coating type magnetic recording media” where the saturation magnetization falls corresponding to the amount of binder (i.e., resin material) included in the magnetic layer to bind the magnetic powder. The included amount of binder also makes it difficult to make the magnetic layer thinner, which makes the magnetic tape thicker and increases the diameter when the magnetic tape is wound. Accordingly, for a wet-coating type magnetic recording medium, it is difficult to make the recording density significantly higher and also difficult to fit a long magnetic recording medium into the limited enclosed space inside a cartridge case.

On the other hand, a “evaporated magnetic recording medium” (as one example, see Japanese Laid-Open Patent Publication No. S59-201221) where a ferromagnetic metal thin film (“magnetic layer”) is formed by depositing a ferromagnetic metal material on a non-magnetic polymer substrate (“non-magnetic substrate”) in a vacuum is known as one example of a magnetic recording medium where a magnetic layer can be thinly formed. With this evaporated magnetic recording medium, even though the magnetic layer is formed thinly, it is possible to increase the saturation magnetization compared to a wet-coating type magnetic recording medium by an amount corresponding to the binder that is omitted from the magnetic layer. Accordingly, it is possible to form a magnetic tape with a thinner overall thickness than a wet-coating type magnetic recording medium and to also reduce the winding diameter of the magnetic tape. By doing so, with an evaporated magnetic recording medium, it is possible to increase the recording density compared to a wet-coating type magnetic recording medium and also possible to fit a long magnetic recording medium into the limited enclosed space inside a cartridge case.

### SUMMARY OF THE INVENTION

However, by investigating the conventional evaporated magnetic recording medium described above, the present inventors found the following issue to be improved. That is, with this type of evaporated magnetic recording medium, since the columns that construct the magnetic layer (i.e., aggregates of crystal grains of the ferromagnetic metal material) grow so as to become inclined to the non-magnetic substrate, the magnetization easy axis of the magnetic layer becomes inclined by a predetermined angle to the longitudinal direction of the main surface of the magnetic recording medium (i.e., inclined to the plane of the non-magnetic substrate). Accordingly, with an evaporated magnetic recording medium, the magnetization characteristics will differ according to the direction in which the tape is running, and due to this, there is a large difference between the signal level of the output signal obtained when the tape is running forward (hereinafter simply “forward output signal”) and the signal level of the output signal obtained when the tape is running in reverse (hereinafter simply “reverse output signal”). On the other hand, to make it possible to record and reproduce data at high speed, current magnetic recording media need to use a construction where bidirectional recording and reproduction can be carried out. Accordingly, it is necessary to suppress the above difference in the signal level of the output signal caused by differences in the running direction of the tape.

In Japanese Laid-Open Patent Publication No. H11-328645, for example, a tape-type magnetic recording medium is disclosed where a first magnetic layer and a second magnetic layer are formed in the mentioned order on one surface of a non-magnetic substrate. With this magnetic recording medium, by forming both magnetic layers by obliquely depositing metal materials onto the non-magnetic substrate (i.e., by growing the columns so as to become inclined to the non-magnetic substrate), the magnetic layers are formed so that the magnetization easy axis of the first magnetic layer is inclined by a predetermined angle to one direction along the longitudinal direction of the main surface of the magnetic recording medium and the magnetization easy axis of the second magnetic layer is inclined by the predetermined angle to the opposite direction along the longitudinal direction of the main surface of the magnetic recording medium. Since the magnetization easy axes of the respective magnetic layers of this magnetic recording medium are inclined in opposite directions, differences in the magnetization characteristics and differences in the signal level of the output signal due to differences in the tape running direction are less likely to appear.

However, when two magnetic layers are formed so that the respective magnetization easy axes are inclined in opposite directions, there are cases where the coercivity falls compared to a magnetic recording medium with a single magnetic layer. More specifically, when the applicant changed the angle of intersection between the plane of the non-magnetic substrate and the magnetic field lines in a state where a magnetic field was applied to the magnetic recording medium and measured the coercivity for each angle of intersection, it was found that for the magnetic recording medium with a single magnetic layer, the coercivity measured when the angle of intersection described above was around 120° greatly falls below the coercivity measured for other angles in the range of the angle of intersection. On the other hand, with a magnetic recording medium with two magnetic layers, although it is possible to avoid the above situation where the coercivity measured when the angle of intersection described above is around 120° greatly falls below the coercivity measured for the other angles in the range of the angle of intersection, it was found that there are many cases where there is an overall fall in the measured coercivity for other angles in the range of the angle of intersection compared to a magnetic recording medium with a single magnetic layer, and in particular there are many cases where there is a large fall in the coercivity measured when the above angle of intersection is around 60°. This means that with a magnetic recording medium with two magnetic layers, when the width of the data recording tracks is reduced and/or when the length of one bit on each data recording track is reduced to increase the recording density, there is the risk that the low coercivity will make it difficult to maintain a sufficient magnetization state for recorded data to be read.

For the magnetic recording medium with a single magnetic layer, although there is a large fall in the signal level of the reverse output signal compared to the signal level of the forward output signal as described above, the signal level of the forward output signal is not problematic for use as a magnetic recording medium for unidirectional recording and reproducing. On the other hand, for the magnetic recording medium with two magnetic layers although the signal level of the forward output signal and the signal level of the reverse output signal are approximately equal with no large difference between them, the signal levels of the output signals in both directions greatly fall below the signal level of the forward output signal of the magnetic recording medium with a single magnetic layer. Accordingly, it is not possible to achieve a sufficient S/N ratio, resulting in deterioration in the error rate (i.e., the margin relating to the error rate during drive design is reduced). This means it is necessary to increase the signal levels of the output signals in both the forward and reverse directions for a magnetic recording medium with two magnetic layers whose magnetization easy axes are inclined in opposite directions. In this way, a magnetic recording medium with two magnetic layers has an issue in that it is difficult to properly reproduce recorded data when data is bidirectionally recorded.

The present invention was conceived in view of the issue described above and it is a principal object of the present invention to provide a magnetic recording medium that is capable of bidirectional recording and reproducing and where the recorded data can be reproduced properly.

A magnetic recording medium according to the present invention includes a metal thin-film magnetic layer formed on a non-magnetic substrate, wherein the metal thin-film magnetic layer is formed so that a coercivity measured when a magnetic field is applied with an angle of intersection of 60° between a plane of the non-magnetic substrate and magnetic field lines of the magnetic field and the coercivity measured when the magnetic field is applied with the angle of intersection of 120° are both at least 160 kA/m. Note that in the present specification, the expression “angle of intersection between the plane of the non-magnetic substrate and magnetic field lines of the magnetic field” refers to the angle of intersection at which magnetic field lines intersect the surface of a non-magnetic substrate in a cross section of the magnetic recording medium along the longitudinal direction of the non-magnetic substrate. Also, the expressions “magnetic field with an angle of intersection of 60°” and “magnetic field with an angle of intersection of 120°” refer to magnetic fields that intersect the surface of the non-magnetic substrate at angles where the magnetic field lines are respectively inclined by 30° to a normal to the non-magnetic substrate. In the present specification, out of the two angles of intersection described above where the angle of inclination to a normal is 30°, the angle of intersection that is closer to the angle of inclination of the magnetization easy axis of the metal thin-film magnetic layer is expressed as “an angle of intersection of 60°”. Also, for a magnetic recording medium where two or more metal thin-film magnetic layers are formed on a non-magnetic substrate, out of the two angles of intersection described above, the angle of intersection that is closer to the angle of inclination of the magnetization easy axis of the metal thin-film magnetic layer closest to the surface is expressed as “an angle of intersection of 60°”.

According to this magnetic recording medium, by forming the metal thin-film magnetic layer so that the coercivity measured in a state where a magnetic field is applied with an angle of intersection of 60° between the plane of the non-magnetic substrate and the magnetic field lines and the coercivity measured in a state where the magnetic field is applied with an angle of intersection of 120° are both at least 160 kA/m, it is possible to make the signal levels of the output signals from a magnetic head substantially equal when the tape is running in both the forward direction and the reverse direction during bidirectional recording and reproducing. In addition, a sufficiently high coercivity can be obtained regardless of the angle of intersection between the plane of the non-magnetic substrate and the magnetic field lines. Accordingly, recording/reproducing control is simplified corresponding to the ability to reproduce recorded data without a large difference in the recording/reproducing conditions between when the tape is running forwards and when the tape is running in reverse, which makes it possible to sufficiently reduce the manufacturing cost of a recording/reproducing apparatus. It is also possible to maintain a sufficient magnetization state for recorded data to be read properly even when the width of the data recording tracks is reduced and/or the length of one bit on each data recording track is reduced to increase the recording density (a state where the influence of adjacent bits in the track width direction and the track length direction becomes prominent). By doing so, it is possible to obtain a sufficiently high S/N ratio, and as a result a magnetic recording medium with a favorable error rate can be provided.

With this magnetic recording medium, the metal thin-film magnetic layer may be formed so that the coercivity measured when the magnetic field is applied with the angle of intersection of 120° is higher than the coercivity measured when the magnetic field is applied with the angle of intersection of 60°.

With this construction, the difference between the signal level of the output signal when the tape is running forwards and the signal level of the output signal when the tape is running in reverse can be suppressed to a significantly smaller value.

Accordingly, the recording/reproducing conditions when the tape is running forwards and when the tape is running in reverse can be set substantially the same.

With this magnetic recording medium, a first magnetic layer and a second magnetic layer may be formed as the metal thin-film magnetic layer in the mentioned order on the non-magnetic substrate so that a ratio of a thickness of the first magnetic layer to a thickness of the second magnetic layer is in a range of 0.60 to 2.10, inclusive, and the first magnetic layer and the second magnetic layer may be comprised of former growth portions and latter growth portions formed on the former growth portions. By doing so, the difference in the signal levels of the output signals when bidirectional recording is carried out on the magnetic recording medium is sufficiently reduced.

It should be noted that the disclosure of the present invention relates to a content of Japanese Patent Application 2006-243492 that was filed on 8 Sep. 2006 and the entire content of which is herein incorporated by reference.

### BRIEF DESCRIPTION OF THE DRAWINGS

These and other objects and features of the present invention will be explained in more detail below with reference to the attached drawings, wherein:

FIG. 1 is a cross-sectional view of a magnetic tape in the longitudinal direction;

FIG. 2 is a schematic view showing the construction of a manufacturing apparatus;

FIG. 3 is a cross-sectional view of a non-magnetic substrate in a state where a first magnetic layer has been formed;

FIG. 4 is a cross-sectional view of the non-magnetic substrate in a state where a second magnetic layer has been formed on the first magnetic layer shown in FIG. 3;

FIG. 5 is a cross-sectional view of the non-magnetic substrate in a state where a protective layer has been formed on the second magnetic layer shown in FIG. 4;

FIG. 6 is a table showing the thicknesses of the magnetic layers, the coercivity, and the output difference (an absolute value) between the forward output and the reverse output of magnetic tapes of Examples 1 to 5 and Comparative Examples 1 to 6;

FIG. 7 is a plan view of a sample fabricated from the magnetic tapes of Examples 1 to 5 and Comparative Examples 1 to 6;

FIG. 8 is a view showing the construction of a vibrating sample magnetometer;

FIG. 9 is a cross-sectional view useful in explaining the relationship between the magnetic tape (sample) and the angle of intersection between the plane of the non-magnetic substrate and the magnetic field lines;

FIG. 10 is a measurement results graph showing measurement results for the coercivity of the magnetic tapes (samples) of Examples 1 to 5; and

FIG. 11 is a measurement results graph showing measurement results for the coercivity of the magnetic tapes (samples) of Comparative Examples 1 to 6.

### DESCRIPTION OF THE PREFERRED EMBODIMENTS

Preferred embodiments of a magnetic recording medium according to the present invention will now be described with reference to the attached drawings.

First, the construction of a magnetic tape 1 that is one example of a magnetic recording medium according to the present invention will be described with reference to the drawings.

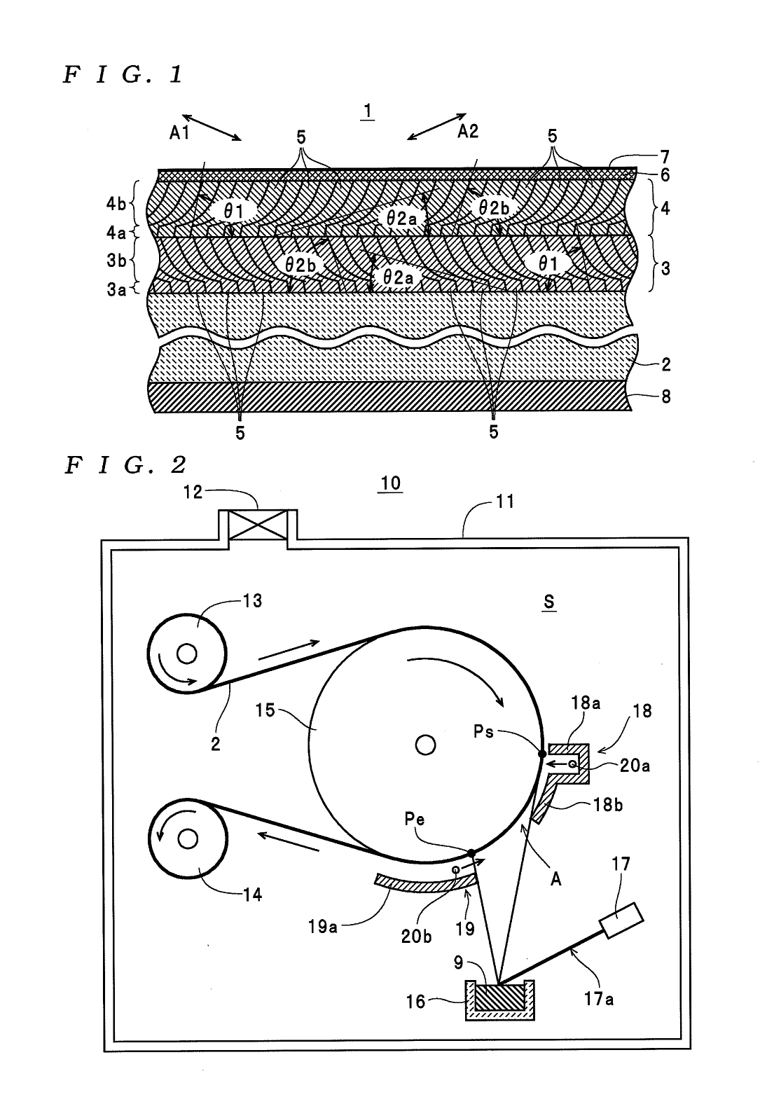

The magnetic tape 1 shown in FIG. 1 is constructed by forming a first magnetic layer 3, a second magnetic layer 4, and a protective layer 6 in the mentioned order on one surface (the upper surface in FIG. 1) of a non-magnetic substrate 2 and forming a back coat layer 8 on the other surface (the lower surface in FIG. 1) of the non-magnetic substrate 2. A lubricant 7 is also applied onto the surface of the protective layer 6. The non-magnetic substrate 2 is formed of a film of a non-magnetic material (as one example, a polymer material) capable of withstanding the heat applied during the formation processes of the magnetic layers 3, 4 and during the formation process of the protective layer 6, described later. As specific examples, the non-magnetic substrate 2 is formed of various types of polymer material such as polyethylene terephthalate (PET), polyethylene naphthalate (PEN), polyamide, polyamide-imide, and polyimide. Here, as one example, the non-magnetic substrate 2 of the magnetic tape 1 is constructed of a polyethylene-2,6-naphthalate (PEN) film with a thickness of 4.7 μm.

The first magnetic layer 3 is one example of a “metal thin-film magnetic layer” for the present invention and as described later is constructed by forming a plurality of columns 5 by depositing a ferromagnetic metal material 9 (see FIG. 2) in a vacuum on one surface of the non-magnetic substrate 2 by oblique evaporation. Here, as examples, Co (cobalt) or a Co alloy that includes cobalt as a main component is used as the ferromagnetic metal material 9 since it is possible to obtain favorable magnetic characteristics, the material cost is comparatively low, and the material is also harmless. Note that to form a magnetic layer with magnetic characteristics suited to recording and reproducing data, the proportion (i.e., percentage content) of Co expressed relative to all of the metal elements included in the ferromagnetic metal material 9 should preferably be at least 60 atomic %, more preferably at least 80 atomic %, and especially at least 90 atomic %. Here, when a Co alloy is used as the ferromagnetic metal material 9, it is preferable to use an alloy with Co and Ni as main components or an alloy with Co, Ni, and Cr as main components, and the percentage content of the respective elements aside from Co in such alloys can be selected as appropriate in accordance with the magnetic characteristics and corrosion resistance required for the magnetic layers.

The first magnetic layer 3 is constructed by consecutively forming former growth portions 3a that comprise respective base end parts of the columns 5 (i.e., the parts of the columns 5 on the non-magnetic substrate 2 side) and latter growth portions 3b that comprise the remaining parts of the columns 5 (i.e., front-end parts or the parts of the columns 5 on the protective layer 6 side) in the mentioned order from the non-magnetic substrate 2 side. Here as described later, the former growth portions 3a are parts that also function as an underlayer to improve the smoothness of the first magnetic layer 3 (i.e., parts that prevent deterioration in the smoothness of the first magnetic layer 3) and are composed of parts where the columns 5 linearly grow in the thickness direction of (i.e., substantially perpendicular to) the non-magnetic substrate 2 during the former stage of a deposition process that deposits the ferromagnetic metal material 9 on the non-magnetic substrate 2 (i.e., during a formation process of the first magnetic layer 3). Note that the expression “in the thickness direction of (i.e., substantially perpendicular to) the non-magnetic substrate 2” given above includes directions that are inclined in a range of around 0° to 10° to a normal to the non-magnetic substrate 2, or in other words, directions with an inclination angle θ1 of around 90° to 80° with respect to the surface of the non-magnetic substrate 2. The applicant has confirmed that when the inclination angle θ1 with respect to the surface of the non-magnetic substrate 2 is below 80°, there is deterioration in the smoothness of the first magnetic layer 3.

With the non-magnetic substrate 2 used for this type of magnetic recording medium, extremely small concaves and convexes are formed on the surface on which the magnetic layers 3, 4 are formed so that concaves and convexes of a sufficient size to reduce the friction during the running of the tape will be formed in the tape surface (i.e., the surfaces of the magnetic layers 3, 4 or the protective layer 6 formed thereupon). With some non-magnetic substrates 2, a layer of resin material in which filler, for example, has been mixed is formed on the opposite surface of the non-magnetic substrate 2 to the surface on which the magnetic layers 3, 4 will be formed (i.e., on the surface of the non-magnetic substrate 2 on which the back coat layer 8 will be formed), with concaves and convexes also being formed in such surface of the non-magnetic substrate 2 to improve the running characteristics of the non-magnetic substrate 2 during the manufacturing of the magnetic recording medium (i.e., to improve the running characteristics of the magnetic recording medium until the formation of the back coat layer has been completed). When this type of non-magnetic substrate 2 is tightly wound, there are cases where the convexes out of the concaves and convexes formed in the surface on which the back coat layer 8 will be formed are transferred to the front surface on which the magnetic layers 3, 4 will be formed, thereby forming concaves and convexes in the front surface. When a metal material is obliquely deposited according to a conventional manufacturing method on the non-magnetic substrate 2 in a state where concaves and convexes have been produced in the surface on which the magnetic layers 3, 4 are formed in this way, it will be difficult for the metal material to adhere to some parts of the concaves in the concaves and convexes on the non-magnetic substrate 2 (in more detail, inclined surfaces on the downstream sides of the concaves during the depositing of metal material or inclined surfaces on the upstream sides of the convexes), so that concaves that are deeper than the concaves of the non-magnetic substrate 2 and convexes that are higher than the convexes of the non-magnetic substrate 2 will be formed in the first magnetic layer during the growth process of the columns.

During the growth process of the columns, the metal material is continuously obliquely deposited onto positions where concaves and convexes have been produced. Accordingly, even deeper concaves and even higher convexes are formed on the surface of the first magnetic layer. This means that large concaves and convexes are produced on the surface of the first magnetic layer. Accordingly, when a second magnetic layer (not shown) is formed by obliquely depositing a metal material according to a conventional manufacturing method onto the first magnetic layer in this state, significantly deeper concaves than the concaves formed in the surface of the first magnetic layer and significantly higher convexes than the convexes formed in the surface of the first magnetic layer are formed in the second magnetic layer, resulting in large concaves and convexes being formed in the surface of the second magnetic layer. Accordingly, with a conventional magnetic recording medium with two magnetic layers, due to the large concaves and convexes produced in the surface of the second magnetic layer, a large spacing loss occurs between a recording/reproducing magnetic head and the surface of a second magnetic layer during the recording and reproducing of data. This means that with a conventional magnetic recording medium, it is believed that the magnetization characteristics of both magnetic layers will deteriorate and that a large fall will occur in the signal level of the output signal during the reading of a magnetic signal.

On the other hand, with the magnetic tape 1, by forming the former growth portions 3a on the non-magnetic substrate 2 during the formation of the first magnetic layer 3, as described later, even if concaves and convexes are present on the surface of the non-magnetic substrate 2, a situation where such concaves and convexes become significantly larger and appear in the surface of the first magnetic layer 3 is avoided, thereby making it possible to form concaves and convexes of substantially the same size as the concaves and convexes of the non-magnetic substrate 2 in the surface of the first magnetic layer 3. The former growth portions 3a are formed as follows. During the formation process of the first magnetic layer 3, by supplying oxygen gas from a start point oxygen supplying unit 18 provided in the vicinity of a deposition start point Ps of a deposition region A (see FIG. 2) where the ferromagnetic metal material 9 will be deposited on the non-magnetic substrate 2, the vaporized ferromagnetic metal material 9 will adhere to the surface of the non-magnetic substrate 2 in a state where the ferromagnetic metal material 9 has been sufficiently mixed with oxygen gas at the depositing start point Ps. Accordingly, the columns 5 are formed so as to grow linearly in the thickness direction of (i.e., substantially perpendicular to) the non-magnetic substrate 2. Also, since the ferromagnetic metal material 9 adheres to the non-magnetic substrate 2 having been mixed with oxygen gas supplied from an oxygen supplying pipe 20a, the former growth portions 3a are formed with Co—O as the main component. When doing so, the amount of oxygen included in the former growth portions 3a should preferably be around 50 atomic % to 60 atomic %.

The thickness of the former growth portions 3a should preferably be in a range of 3 nm to 50 nm, inclusive. If the thickness is in this range of 3 nm to 50 nm, inclusive, it is possible for the base end parts of the columns 5 (i.e., the parts that construct the former growth portions 3a) to grow sufficiently finely and uniformly. Accordingly, it is also possible for the front end parts of the columns 5 (i.e., the parts that construct the latter growth portions 3b) that grow after the former growth portions 3a to grow sufficiently finely and uniformly. In addition, by setting the thickness of the former growth portions 3a in the range of 3 nm to 50 nm, inclusive, it will be easy to align the c axis orientations of the Co (hexagonal crystals) in the columns 5 in the latter growth portions 3b that are formed after the former growth portions 3a (i.e., easy to align the origins of crystal magnetic anisotropy). By doing so, the latter growth portions 3b can have sufficiently high coercivity and sufficiently high remnant magnetization, and as a result, it is possible to achieve a sufficiently high C/N ratio. Also, by setting the thickness of the former growth portions 3a in the range of 3 nm to 50 nm, inclusive, even when concaves and convexes are present in the surface of the non-magnetic substrate 2, it will be possible to form concaves and convexes of substantially the same size as the concaves and convexes of the non-magnetic substrate 2 in the surface of the first magnetic layer 3 without causing deterioration in the smoothness of the first magnetic layer 3.

On the other hand, when the thickness of the former growth portions 3a is below 3 nm, it is difficult to make the base end parts of the columns 5 grow uniformly and finely. Accordingly, there is the risk that it will be difficult to make the front end parts of the columns 5 also grow uniformly and finely after the former growth portions 3a have been formed. In addition, when the thickness of the former growth portions 3a is below 3 nm, there is the risk that the c axis orientations of the Co (hexagonal crystals) in the columns 5 in the latter growth portions 3b will not be aligned (i.e., that the origins of crystal magnetic anisotropy will not be aligned). Accordingly, since there is a fall in the coercivity and remnant magnetization of the latter growth portions 3b, there is the risk that it will be difficult to achieve a high C/N ratio. Also, if the thickness of the former growth portions 3a is below 3 nm, there is the risk when concaves and convexes are present in the surface of the non-magnetic substrate 2 that larger concaves and convexes will be formed in the surface of the first magnetic layer 3.

On the other hand, when the thickness of the former growth portions 3a is above 50 nm, there is the risk that the columns 5 will grow too large in both the plane and the thickness directions of the first magnetic layer 3, resulting in large concaves and convexes being produced at the boundaries between the former growth portions 3a and the latter growth portions 3b. This would result in the risk of large concaves and convexes being produced in the surface of the latter growth portions 3b, that is, in the surface of the first magnetic layer 3. Also, when the thickness of the former growth portions 3a is above 50 nm, there is the risk of the winding diameter of the magnetic tape 1 becoming too large due to the first magnetic layer 3 being too thick. Note that for the magnetic tape 1, as one example the thickness of the former growth portions 3a in the first magnetic layer 3 is set at 5 nm.

The latter growth portions 3b are composed of parts formed by causing the columns 5 to continuously grow on the former growth portions 3a during the process that deposits the ferromagnetic metal material 9 on the non-magnetic substrate 2 (i.e., the formation process of the first magnetic layer 3). That is, the latter growth portions 3b are composed of the respective front end parts of the columns 5. More specifically, the latter growth portions 3b are composed of parts produced by causing the columns 5 (i.e., the parts that construct the former growth portions 3a) that have grown on the non-magnetic substrate 2 during the former stage of the deposition process for the ferromagnetic metal material 9 to further grow so as to become inclined to the longitudinal direction of the non-magnetic substrate 2 and arc-shaped in profile. Note that for a conventional magnetic recording medium with two magnetic layers, the magnetic layer on the non-magnetic substrate side has the same construction as when only these latter growth portions 3b are formed.

With the magnetic tape 1, as described later, the non-magnetic substrate 2 is run around the circumferential surface of a rotating cooling drum 15 (see FIG. 2) while depositing the ferromagnetic metal material 9 to form the first magnetic layer 3. Accordingly, the inclination angle θ2a of parts formed at positions that are adjacent to the deposition start point Ps on the deposition end point Pe side of the deposition region A in which the ferromagnetic metal material 9 is deposited on the non-magnetic substrate 2 (i.e., the inclination angle θ2a of the base ends of the latter growth portions 3b of the columns 5) will be in a range of around 10° to 60°, the inclination angle θ2a will gradually increase, and the inclination angle θ2b of the parts formed near the deposition end point Pe of the deposition region A (i.e., the inclination angle θ2b of the front ends of the latter growth portions 3b of the columns 5) will become the maximum (in a range of around 30° to 90°), so that the parts that construct the latter growth portions 3b of the columns 5 become arc-shaped in profile.

The latter growth portions 3b are formed with Co as the main component and include a smaller amount of oxygen than the former growth portions 3a described earlier. Here, the amount of oxygen included in the latter growth portions 3b should preferably be in a range of 20 atomic % to 50 atomic %. Also, the thickness of the latter growth portions 3b should preferably be in a range of 10 nm to 300 nm, inclusive. If the thickness is in this range, the parts that construct the latter growth portions 3b (i.e., the front end parts) formed following the parts that construct the former growth portions 3a (i.e., the base end parts) of the columns 5 can grow sufficiently finely and uniformly, and therefore it is possible to sufficiently improve the smoothness of the surface of the latter growth portions 3b (that is, the surface of the first magnetic layer 3). By doing so, it is possible to reduce the spacing loss between the magnetic tape 1 and the magnetic head during recording and reproducing, and as a result, it is possible to achieve a sufficiently high C/N ratio.

On the other hand, when the thickness of the latter growth portions 3b is below 10 nm, there is the risk that it will be difficult to achieve sufficiently high levels for the coercivity and remnant magnetization of the latter growth portions 3b. On the other hand, when the thickness of the latter growth portions 3b exceeds 300 nm, the parts that construct the latter growth portions 3b of the columns 5 (i.e., the front end parts) will grow excessively in both the plane and the thickness directions of the first magnetic layer 3, resulting in deterioration in the smoothness of the latter growth portions 3b and an increase in the spacing loss during recording and reproducing. Accordingly, there is the risk of difficulty in achieving a high C/N ratio. Note that for the magnetic tape 1, as one example the thickness of the latter growth portions 3b of the first magnetic layer 3 is set at 38 nm.

In this way, when a construction is used where the former growth portions 3a are formed inside the first magnetic layer 3, in view of the combination of a sufficient thickness to obtain the various effects described above due to the formation of the former growth portions 3a and a sufficient thickness to obtain the various effects described above due to the formation of the latter growth portions 3b, the thickness of the latter growth portions 3b should preferably be greater than the thickness of the former growth portions 3a. More specifically, the thicknesses of the former growth portions 3a and the latter growth portions 3b should preferably be set so that the ratio of the thickness of the former growth portions 3a to the thickness of the latter growth portions 3b is in a range of 0.08 to 0.15, inclusive (in this example, 0.13).

The second magnetic layer 4 is another example of a “metal thin-film magnetic layer” and as shown in FIG. 1, the second magnetic layer 4 is constructed by forming a plurality of columns 5 by depositing the ferromagnetic metal material 9 in a vacuum on the first magnetic layer 3 formed on the non-magnetic substrate 2 by oblique evaporation. Note that since the ferromagnetic metal material 9 used to form the second magnetic layer 4 is the same as the ferromagnetic metal material 9 used to form the first magnetic layer 3, duplicated description thereof is omitted.

The second magnetic layer 4 is constructed by consecutively forming former growth portions 4a that comprise respective base end parts of the columns 5 described above (i.e., the parts of the columns 5 on the non-magnetic substrate 2 side) and latter growth portions 4b that comprise the remaining parts of the columns 5 (i.e., front end parts or the parts of the columns 5 on the protective layer 6 side) in the mentioned order from the non-magnetic substrate 2 side on top of the first magnetic layer 3. Here, as described later and in the same way as the former growth portions 3a of the first magnetic layer 3 described earlier, the former growth portions 4a are the parts that function as an underlayer to improve the smoothness of the second magnetic layer 4 (i.e., parts that prevent deterioration in the smoothness of the second magnetic layer 4). With the magnetic tape 1, by forming the former growth portions 4a on the first magnetic layer 3 when forming the second magnetic layer 4, as described later, even if concaves and convexes are present in the surface of the first magnetic layer 3, a situation where the concaves and convexes become significantly larger and appear on the surface of the second magnetic layer 4 is avoided and it becomes possible to form concaves and convexes of substantially the same size as the concaves and convexes of the first magnetic layer 3, that is, the same size as the concaves and convexes of the non-magnetic substrate 2 in the surface of the second magnetic layer 4. During the former stage of the deposition process for the ferromagnetic metal material 9 (i.e., the formation process of the second magnetic layer 4), the former growth portions 4a are constructed as parts where columns 5 linearly grow in the thickness direction of (i.e., substantially perpendicular to) the non-magnetic substrate 2.

Note that the expression “in the thickness direction of (i.e., substantially perpendicular to) the non-magnetic substrate 2” given above includes directions that are inclined in a range of around 0° to 10° to a normal to the non-magnetic substrate 2, or in other words, directions with an inclination angle θ1 of around 90° to 80° with respect to the surface of the non-magnetic substrate 2. The applicant has confirmed that when the inclination angle θ with respect to the surface of the non-magnetic substrate 2 is below 80°, there is deterioration in the smoothness of the second magnetic layer 4.

Like the former growth portions 3a of the first magnetic layer 3 described earlier, since the former growth portions 4a are formed by supplying oxygen gas from the start point oxygen supplying unit 18 provided in the vicinity of the deposition start point Ps (see FIG. 2) of the deposition region A where the ferromagnetic metal material 9 will be deposited, the vaporized ferromagnetic metal material 9 will adhere to the surface of the first magnetic layer 3 in a state where the ferromagnetic metal material 9 has been sufficiently mixed with oxygen gas at the deposition start point Ps. Accordingly, the columns 5 are formed so as to grow linearly in the thickness direction of (i.e., substantially perpendicular to) the non-magnetic substrate 2. Also, since the ferromagnetic metal material 9 adheres to the first magnetic layer 3 having been mixed with oxygen gas supplied from an oxygen supplying pipe 20a, the former growth portions 4a are formed with Co—O as the main component. When doing so, the amount of oxygen included in the former growth portions 4a should preferably be around 50 atomic % to 60 atomic %. The thickness of the former growth portions 4a should preferably be in a range of 3 nm to 50 nm, inclusive for the same reasons as the thickness of the former growth portions 3a described earlier. Note that for the magnetic tape 1, as one example the thickness of the former growth portions 4a in the second magnetic layer 4 is set at 5 nm.

Like the latter growth portions 3b of the first magnetic layer 3, the latter growth portions 4b are composed of parts formed by continuously growing the columns 5 on the former growth portions 4a during the process that deposits the ferromagnetic metal material 9 (i.e., the formation process of the second magnetic layer 4). That is, the latter growth portions 4b are composed of the respective front end parts of the columns 5. More specifically, the latter growth portions 4b are composed of parts produced by causing the columns 5 (i.e., the parts that construct the former growth portions 4a) that have grown on the first magnetic layer 3 in the former stage of the deposition process for the ferromagnetic metal material 9 to further grow so as to become inclined to the longitudinal direction of the non-magnetic substrate 2 and arc-shaped in profile. Note that in the same way as the latter growth portions 3b, the inclination angle θ2a of the base end parts of the columns 5 is in a range of around 10° to 60°, the inclination angle θ2a gradually increases, and the inclination angle θ2b of the front end parts of the columns 5 becomes the maximum (in a range of around 30° to 90°), so that the parts that construct the latter growth portions 4b of the columns 5 become arc-shaped in profile. Note that the surface-side magnetic layer of a conventional magnetic recording medium with two magnetic layers and the magnetic layer of a conventional magnetic recording medium with a single magnetic recording layer are constructed in the same way as when only these latter growth portions 4b are formed.

The latter growth portions 4b are formed with Co as the main component and include a smaller amount of oxygen than the former growth portions 4a described earlier. Here, the amount of oxygen included in the latter growth portions 4b should preferably be in a range of 20 atomic % to 50 atomic %. Also, for the same reasons as the thickness of the latter growth portions 3b of the first magnetic layer 3 described earlier, the thickness of the latter growth portions 4b should preferably be in the range of 10 nm to 300 nm, inclusive. Note that for the magnetic tape 1, as one example the thickness of the latter growth portions 4b of the second magnetic layer 4 is set at 35 nm.

In this way, when a construction is used where the former growth portions 4a are formed inside the second magnetic layer 4, in view of the combination of a sufficient thickness to obtain the various effects described above due to the formation of the former growth portions 4a and a sufficient thickness to obtain the various effects described above due to the formation of the latter growth portions 4b, the thickness of the latter growth portions 4b should preferably be greater than the thickness of the former growth portions 4a. More specifically, the thicknesses of the former growth portions 4a and the latter growth portions 4b should preferably be set so that the ratio of the thickness of the former growth portions 4a to the thickness of the latter growth portions 4b is in a range of 0.08 to 0.15, inclusive (in this example, 0.14).

With the magnetic tape 1, as shown in FIG. 1, the first magnetic layer 3 and the second magnetic layer 4 are formed so that the parts that construct the latter growth portions 3b of the columns 5 in the first magnetic layer 3 and the parts that construct the latter growth portions 4b of the columns 5 in the second magnetic layer 4 are inclined in opposite directions with respect to the thickness direction of (i.e., along a normal to) the non-magnetic substrate 2. Accordingly, with the magnetic tape 1, the orientation of the magnetization easy axis of the first magnetic layer 3 (i.e., the orientation shown by the arrow A1 in FIG. 1) and the orientation of the magnetization easy axis of the second magnetic layer 4 (i.e., the orientation shown by the arrow A2 in FIG. 1) are inclined in opposite directions, which as described later, prevents differences in the magnetization characteristics and differences in the signal level of the output signal from appearing when bidirectional recording is carried out on the magnetic tape 1. With the magnetic tape 1, the first magnetic layer 3 and the second magnetic layer 4 are formed so that the ratio of the thickness of the first magnetic layer 3 to the thickness of the second magnetic layer 4 is in a range of 0.60 to 2.10, inclusive (in this example, 1.08). By doing so, the difference in the signal levels of the output signals when bidirectional recording is carried out on the magnetic tape 1 is sufficiently reduced.

In addition, with the magnetic tape 1, the coercivity Hc measured in a state where a magnetic field is applied with the angle of intersection of 60° between the plane of the non-magnetic substrate 2 and the magnetic field lines is around 174 kA/m and the coercivity Hc measured in a state where a magnetic field is applied with the angle of intersection of 120° between the plane of the non-magnetic substrate 2 and the magnetic field lines is around 183 kA/m. In this case, the applicant found that by setting the thickness of the first magnetic layer 3 and the thickness of the second magnetic layer 4 and the thicknesses of the former growth portions 3a, 4a and the thickness of the latter growth portions 3b, 4b so that the coercivity Hc measured when the magnetic field is applied with the angle of intersection described above of 60° and the coercivity Hc measured when the magnetic field is applied with the angle of intersection of 120° are both 160 kA/m or above, the signal level of the forward output signal and the signal level of the reverse output signal can both be improved and the difference in the signal level of the output signal due to the difference in the tape running direction can be sufficiently reduced. Note that the relationship between the coercivity Hc and differences due to the signal level of the output signal and differences in the tape running direction will be described in detail later.

The protective layer 6 is a thin film that prevents oxidization of the magnetic layers 3, 4 described above and also prevents abrasion of the magnetic layers 3, 4, and as one example is formed of DLC (Diamond Like Carbon). As examples of the lubricant 7, a lubricant that includes fluorine, a hydrocarbon series ester, or a mixture of the same is used. The back coat layer 8 is formed with a thickness in a range of around 0.1 μm to 0.7 μm by applying and hardening a back coat layer coating composition produced by mixing and dispersing a binder resin (binder) and an inorganic compound and/or carbon black in an organic solvent. Here, it is possible to use any of a vinyl chloride copolymer, polyurethane resin, acrylic resin, epoxy resin, phenoxy resin, and polyester resin, or a mixture of the same, as the binder resin. As the carbon black, it is possible to use furnace carbon black, thermal carbon black, or the like, and as the inorganic compound, it is possible to use calcium carbonate, alumina, α-iron oxide or the like. In addition, as the organic solvent, it is possible to use a ketone or aromatic hydrocarbon solvent (for example, methyl ethyl ketone, toluene, and cyclohexanone).

Next, the construction of a magnetic tape manufacturing apparatus 10 constructed so as to be capable of manufacturing the magnetic tape 1 described above and the method of manufacturing the magnetic tape 1 will be described with reference to the drawings.

The magnetic tape manufacturing apparatus (hereinafter simply “manufacturing apparatus”) 10 shown in FIG. 2 is constructed by enclosing a feed roll 13, a winding roll 14, the rotating cooling drum 15, a crucible 16, an electron gun 17, the start point oxygen supplying unit 18, and an end point oxygen supplying unit 19 inside a vacuum chamber 11 and is constructed so as to be capable of forming both the magnetic layers 3, 4 described above. A vacuum pump 12 for evacuating air in the internal space S to maintain a vacuum is attached to the vacuum chamber 11.

The feed roll 13 rotates a roll into which the non-magnetic substrate 2 (on which the first magnetic layer 3 or the second magnetic layer 4 is to be formed) has been wound to feed the non-magnetic substrate 2 toward the rotating cooling drum 15. The winding roll 14 winds the non-magnetic substrate 2, on which the first magnetic layer 3 or the second magnetic layer 4 has been formed, into a roll. The rotating cooling drum 15 drives the non-magnetic substrate 2 fed from the feed roll 13 around the circumferential surface thereof while cooling the non-magnetic substrate 2. Note that although in reality, guide rollers and the like are present between the feed roll 13 and the rotating cooling drum 15 and between the rotating cooling drum 15 and the winding roll 14, for ease of understanding the present invention, such parts have been omitted from the drawings and this description.

The crucible 16 is formed of MgO or the like, for example, and stores the ferromagnetic metal material 9 (in this example, Co) that is regularly supplied by a material supplying apparatus, not shown. The crucible 16 is positioned so that the ferromagnetic metal material 9 that is vaporized by irradiation with an electron beam 17a outputted from the electron gun 17 is obliquely deposited on the surface of the non-magnetic substrate 2 running around the circumferential surface of the rotating cooling drum 15. The electron gun 17 outputs the electron beam 17a to vaporize the ferromagnetic metal material 9 inside the crucible 16.

The start point oxygen supplying unit 18 includes an oxygen mixing chamber 18a, a mask 18b, and an oxygen supplying pipe 20a and is disposed upstream in the running direction of the non-magnetic substrate 2. The oxygen mixing chamber 18a is formed in a box-like shape whose length in the width direction of the non-magnetic substrate 2 (i.e., perpendicular to the plane of the paper in FIG. 2) that is running around the circumferential surface of the rotating cooling drum 15 is slightly larger than the width of the non-magnetic substrate 2, and is disposed so that an open side of the oxygen mixing chamber 18a faces the circumferential surface of the rotating cooling drum 15 (i.e., faces the surface of the non-magnetic substrate 2). The width of the oxygen mixing chamber 18a (i.e., the length of the opening in the running direction of the non-magnetic substrate 2) is set in accordance with various conditions, such as the thicknesses of the former growth portions 3a, 4a to be formed in the first magnetic layer 3 and the second magnetic layer 4, the diameter of the rotating cooling drum 15, and the running speed of the non-magnetic substrate 2.

The oxygen supplying pipe 20a disposed inside the oxygen mixing chamber 18a supplies oxygen gas to the deposition start point Ps end of the deposition region A. The oxygen supplying pipe 20a is constructed by forming a plurality of oxygen gas supply openings (as examples, round holes and/or slits) along the width of the non-magnetic substrate 2. The applicant has found that by disposing the oxygen mixing chamber 18a near the deposition start point Ps and mixing the ferromagnetic metal material 9 vaporized from the crucible 16 with the oxygen gas supplied from the oxygen supplying pipe 20a inside the oxygen mixing chamber 18a to disperse the vaporized component of the ferromagnetic metal material 9 in the oxygen gas, the former growth portions 3a, 4a are formed due to the columns 5 that grow on the non-magnetic substrate 2 linearly growing in the thickness direction of (i.e., along a normal or substantially perpendicular to) the non-magnetic substrate 2.

The mask 18b prevents the ferromagnetic metal material 9 vaporized from the crucible 16 from adhering to the non-magnetic substrate 2 (by covering the non-magnetic substrate 2) to set the deposition start point Ps of the deposition region A. By adjusting the disposed position of the mask 18b relative to the rotating cooling drum 15, the maximum angle at which the ferromagnetic metal material 9 adheres to the non-magnetic substrate 2 (here, an angle between a normal for the non-magnetic substrate 2 in the part to which the ferromagnetic metal material 9 adheres and the direction in which the crucible 16 is present as viewed from the part to which the ferromagnetic metal material 9 adheres) is set.

The end point oxygen supplying unit 19 includes a mask 19a and an oxygen supplying pipe 20b, and is disposed downstream in the running direction of the non-magnetic substrate 2. The mask 19a prevents the ferromagnetic metal material 9 vaporized from the crucible 16 from adhering to the non-magnetic substrate 2 (by covering the non-magnetic substrate 2) to set the deposition end point Pe of the deposition region A. Also, by adjusting the disposed position of the mask 19a relative to the rotating cooling drum 15, the minimum angle at which the ferromagnetic metal material 9 adheres to the non-magnetic substrate 2 (here, an angle between a normal for the non-magnetic substrate 2 and the direction in which the crucible 16 is present) is set.

The oxygen supplying pipe 20b is disposed between the mask 19a and the rotating cooling drum 15 and is disposed near the deposition end point Pe end of the deposition region A described above. The oxygen supplying pipe 20b is constructed by forming a plurality of oxygen gas supply openings (as examples, round holes and/or slits) along the width of the non-magnetic substrate 2. Here, the oxygen gas supplied by the end point gas supplying unit 19 is introduced with the aim of improving the saturation flux density, coercivity, and electromagnetic conversion characteristics of the first magnetic layer 3 and the second magnetic layer 4 being formed.

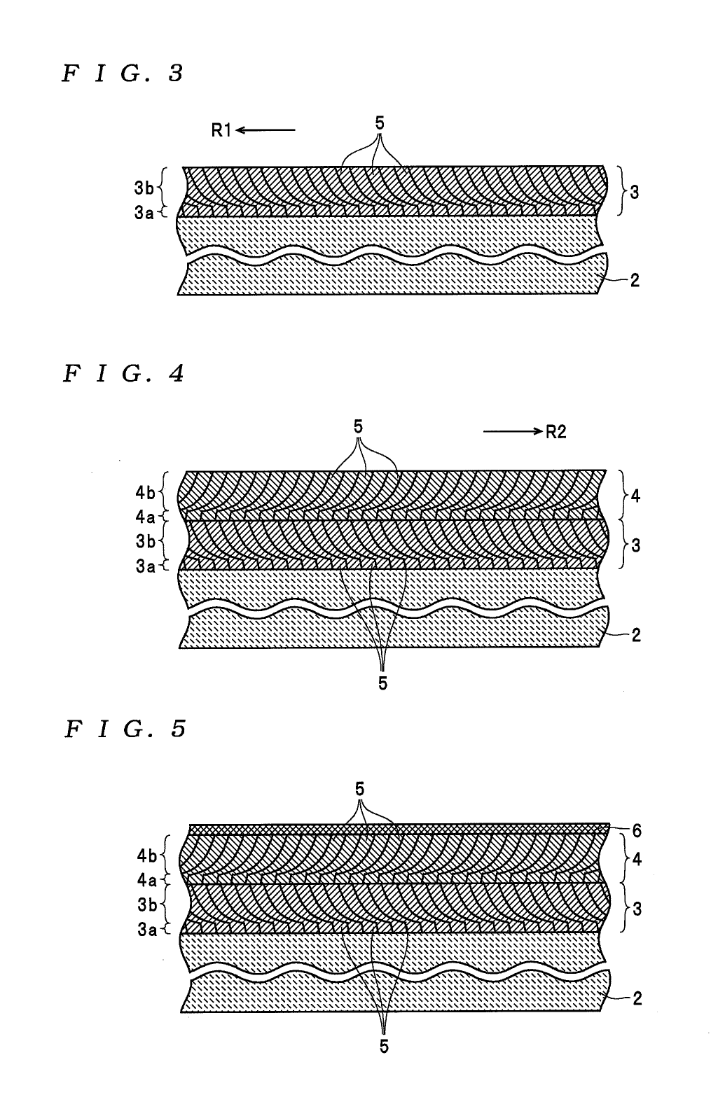

On the other hand, when manufacturing the magnetic tape 1, by using the manufacturing apparatus 10, the first magnetic layer 3 is formed on the non-magnetic substrate 2 as shown in FIG. 3 and then the second magnetic layer 4 is formed on the formed first magnetic layer 3 as shown in FIG. 4. That is, by twice carrying out a depositing process that deposits ferromagnetic metal material 9 on the non-magnetic substrate 2, the first magnetic layer 3 and the second magnetic layer 4 are formed in the mentioned order on the non-magnetic substrate 2.

More specifically, first an original roll, which has been produced by winding the non-magnetic substrate 2 on which the first magnetic layer 3 will be formed, is set on the feed roll 13, the non-magnetic substrate 2 is placed around the circumferential surface of the rotating cooling drum 15, and the end of the non-magnetic substrate 2 is fixed to the winding roll 14. Next, after the vacuum pump 12 has been driven to evacuate the vacuum chamber 11 to a pressure of around 10⁻³ Pa, the feed roll 13, the winding roll 14, and the rotating cooling drum 15 are rotated to run the non-magnetic substrate 2 around the circumferential surface of the rotating cooling drum 15. After this, the ferromagnetic metal material 9 is vaporized by emitting the electron beam 17a from the electron gun 17 toward the ferromagnetic metal material 9 inside the crucible 16 and the supplying of oxygen gas from the oxygen supplying pipes 20a, 20b is commenced. When doing so, the electron gun 17 scans the electron beam 17a (i.e., moves the electron beam 17a right and left) with a predetermined pitch in the width direction of the non-magnetic substrate 2. By doing so, the ferromagnetic metal material 9 is heated and vaporized inside the crucible 16.

When doing so, out of the ferromagnetic metal material 9 vaporized from the crucible 16, a large amount of the ferromagnetic metal material 9 that reaches the vicinity of the deposition start point Ps becomes mixed with the oxygen gas supplied from the oxygen supplying pipe 20a inside the oxygen mixing chamber 18a. The ferromagnetic metal material 9 mixed with the oxygen gas collides with the oxygen gas, thereby changing the direction in which the ferromagnetic metal material 9 moves to a variety of directions. As a result, the ferromagnetic metal material 9 accumulates on and adheres to the non-magnetic substrate 2 running around the circumferential surface of the rotating cooling drum 15. By doing so, the base end parts of the columns 5 that construct the first magnetic layer 3 grow on the non-magnetic substrate 2 so that the formation of the former growth portions 3a of the first magnetic layer 3 proceeds.

If the ferromagnetic metal material 9 is caused to adhere to the non-magnetic substrate 2 using a typical conventional method of oblique evaporation, when extremely small concaves and convexes are present in the surface of the non-magnetic substrate 2, it will be difficult for the ferromagnetic metal material 9 to adhere to the upstream sides of the convexes in the running direction of the non-magnetic substrate 2 and the ferromagnetic metal material 9 will adhere to only the downstream sides of the convexes in the running direction. Accordingly, with conventional oblique evaporation, as described earlier when extremely small concaves and convexes are present on the non-magnetic substrate 2, convexes appear on the surface of the first magnetic layer 3 with an exaggerated (enlarged) size. This results in a tendency for deterioration in the smoothness of the first magnetic layer 3.

On the other hand, with the manufacturing apparatus 10 where the ferromagnetic metal material 9 adheres to the non-magnetic substrate 2 in a state where the ferromagnetic metal material 9 has been mixed with oxygen gas in the vicinity of the deposition start point Ps, mixing the ferromagnetic metal material 9 that was vaporized from the crucible 16 with the oxygen gas inside the oxygen mixing chamber 18a results in the ferromagnetic metal material 9 adhering to the non-magnetic substrate 2 in directions that are unrelated to the direction in which the ferromagnetic metal material 9 has arrived from the crucible 16. Accordingly, the ferromagnetic metal material 9 adheres in the thickness direction of (i.e., along a normal or substantially perpendicular to) the non-magnetic substrate 2, resulting in the base end parts of the columns 5 growing linearly to form the former growth portions 3a on the non-magnetic substrate 2. Therefore, even if extremely small concaves and convexes are present in the surface of the non-magnetic substrate 2, the ferromagnetic metal material 9 will adhere in the same way to both the upstream sides and the downstream sides of the convexes in the running direction of the non-magnetic substrate 2. As a result, a situation where larger concaves and convexes than the concaves and convexes of the non-magnetic substrate 2 are formed during the formation of the former growth portions 3a is avoided and concaves and convexes of substantially the same size as the concaves and convexes of the non-magnetic substrate 2 are formed in the surface of the first magnetic layer 3.

Note that the expression “deposition start point Ps” in this specification refers to a deposition start point in geometric terms that is set based on the relationship between the position of the crucible 16 and the position of the rotating cooling drum 15, and that in reality, there are cases where in accordance with the size of the oxygen mixing chamber 18a, the amount of oxygen gas fed from the oxygen supplying pipe 20a, and the vaporized amount of the ferromagnetic metal material 9, deposition of the ferromagnetic metal material 9 on the non-magnetic substrate 2 starts further upstream than the deposition start point Ps shown in FIG. 2.

After the former growth portions 3a have been formed at the position of the start point oxygen supplying unit 18, the non-magnetic substrate 2 runs around the circumferential surface of the rotating cooling drum 15 and moves to an area between the masks 18b, 19a. When doing so, since the ferromagnetic metal material 9 that has been vaporized and emitted from the crucible 16 adheres to the former growth portions 3a described above (i.e., the base end parts of the columns 5), during the period until the non-magnetic substrate 2 reaches the deposition end point Pe, the latter growth portions 3b are formed on the former growth portions 3a due to the columns 5 continuously growing from the base end parts (i.e., the parts that construct the former growth portions 3a). During the period from immediately after the non-magnetic substrate 2 becomes exposed from the mask 18b until when the non-magnetic substrate 2 is covered by the mask 19a, the direction in which the crucible 16 is positioned relative to the non-magnetic substrate 2 (i.e., the direction in which the ferromagnetic metal material 9 reaches the non-magnetic substrate 2 from the crucible 16) constantly changes, and as a result, as shown in FIG. 3, the front end parts of the columns 5 (i.e., the parts that construct the latter growth portions 3b) grow so as to become inclined toward the downstream side in the running direction of the non-magnetic substrate 2 and arc-shaped in profile. Note that in FIG. 3, a state where the non-magnetic substrate 2 is running in the direction of the arrow R1 is shown.

By forming the former growth portions 3a on the non-magnetic substrate 2, even if concaves and convexes are present in the surface of the non-magnetic substrate 2, during the formation of the former growth portions 3a such concaves and convexes will be covered by the ferromagnetic metal material 9 and oxide thereof so that the degree (size) of the concaves and convexes is sufficiently reduced. Accordingly, a situation where concaves and convexes that are larger than the concaves and convexes present in the surface of the non-magnetic substrate 2 are formed during the formation of the latter growth portions 3b that are formed on the former growth portions 3a is avoided, and as a result concaves and convexes of substantially the same size as the concaves and convexes present in the surface of the non-magnetic substrate 2 are formed in the surface of the latter growth portions 3b, that is, in the surface of the first magnetic layer 3. By doing so, a first magnetic layer 3 with the desired smoothness is formed on the non-magnetic substrate 2. The thickness of the latter growth portions 3b can be set at a desired thickness by appropriately adjusting the position of the mask 19a, the running speed of the non-magnetic substrate 2, and the vaporized amount of the ferromagnetic metal material 9.

Note that like the deposition start point Ps described earlier, the “deposition end point Pe” described above refers to a geometric deposition end point and that in reality, due to the running speed of the non-magnetic substrate 2, the vaporized amount of the ferromagnetic metal material 9, and/or the ferromagnetic metal material 9 getting behind the mask 19a, there are cases where deposition of the ferromagnetic metal material 9 on the non-magnetic substrate 2 continues further downstream than the deposition end point Pe shown in FIG. 2.

After this, the non-magnetic substrate 2 on which the formation of the former growth portions 3a and the latter growth portions 3b has been completed (i.e., the formation of the first magnetic layer 3 has been completed) is separated from the circumferential surface of the rotating cooling drum 15 and is wound onto the winding roll 14. By doing so, the first out of the two deposition processes is completed.

Next, an original roll produced by winding the non-magnetic substrate 2 on which the formation of the first magnetic layer 3 has been completed is set on the feed roll 13, the non-magnetic substrate 2 is placed around the circumferential surface of the rotating cooling drum 15, and the end of the non-magnetic substrate 2 is fixed to the winding roll 14. Next, after the vacuum pump 12 has been driven to evacuate the vacuum chamber 11, the feed roll 13, the winding roll 14, and the rotating cooling drum 15 are rotated to run the non-magnetic substrate 2 around the circumferential surface of the rotating cooling drum 15. When doing so, the non-magnetic substrate 2 runs in the opposite direction to the formation process of the first magnetic layer 3 described earlier. Next, the ferromagnetic metal material 9 is vaporized by emitting the electron beam 17a from the electron gun 17 toward the ferromagnetic metal material 9 inside the crucible 16 and the supplying of oxygen gas from the oxygen supplying pipes 20a, 20b is commenced.

When doing so, in the same way as the formation process of the former growth portions 3a and the latter growth portions 3b described earlier, the former growth portions 4a and the latter growth portions 4b are formed on the first magnetic layer 3 as shown in FIG. 4. Note that in FIG. 4, the state where the non-magnetic substrate 2 is running in the direction of the arrow R2 is shown. Here, in the same way as the former growth portions 3a described earlier, by forming the former growth portions 4a on the first magnetic layer 3 during a former stage (i.e., in the vicinity of the oxygen mixing chamber 18a) during the formation process for the second magnetic layer 4, even if concaves and convexes are present on the surface of the first magnetic layer 3, the concaves and convexes will be covered with the ferromagnetic metal material 9 and the oxide thereof during the formation process of the former growth portions 4a, so that the degree (i.e., size) of the concaves and convexes can be sufficiently reduced. Accordingly, a situation where larger concaves and convexes than the concaves and convexes of the first magnetic layer 3 are formed during the formation of the latter growth portions 4b formed on the former growth portions 4a is avoided and as a result, concaves and convexes of substantially the same size as the concaves and convexes of the first magnetic layer 3 are formed in the surface of the latter growth portions 4b, that is, in the surface of the second magnetic layer 4. By doing so, a second magnetic layer 4 with the desired smoothness is formed on the first magnetic layer 3. After this, the non-magnetic substrate 2 on which the formation of the former growth portions 4a and the latter growth portions 4b has been completed (i.e., the formation of the second magnetic layer 4 has been completed) is separated from the circumferential surface of the rotating cooling drum 15 and is wound onto the winding roll 14. By doing so, the second out of the two deposition processes is completed.

After this, as shown in FIG. 5, a protective layer forming apparatus (not shown) is used to form the protective layer 6 by causing DLC to adhere to the surface of the second magnetic layer 4. Next, by applying the back coat layer coating composition to the rear surface side of the non-magnetic substrate 2 and drying the back coat layer coating composition, the back coat layer 8 is formed. The lubricant 7 is applied onto the surface of the protective layer 6. In this way, a series of manufacturing processes for the magnetic tape 1 is completed and as shown in FIG. 1, the magnetic tape 1 is completed. Note that although the magnetic tape to be enclosed in a tape cartridge as the final product is manufactured by cutting the non-magnetic substrate 2 onto which the lubricant 7 has been applied into predetermined tape widths, for ease of understanding the present invention, description and illustration of such process have been omitted.

Next, the relationship between coercivity Hc measured in a state where various magnetic fields are applied with magnetic field lines at different angles of intersection and the signal level of the output signal from the reproducing head during reproducing will be described with reference to examples and comparative examples.

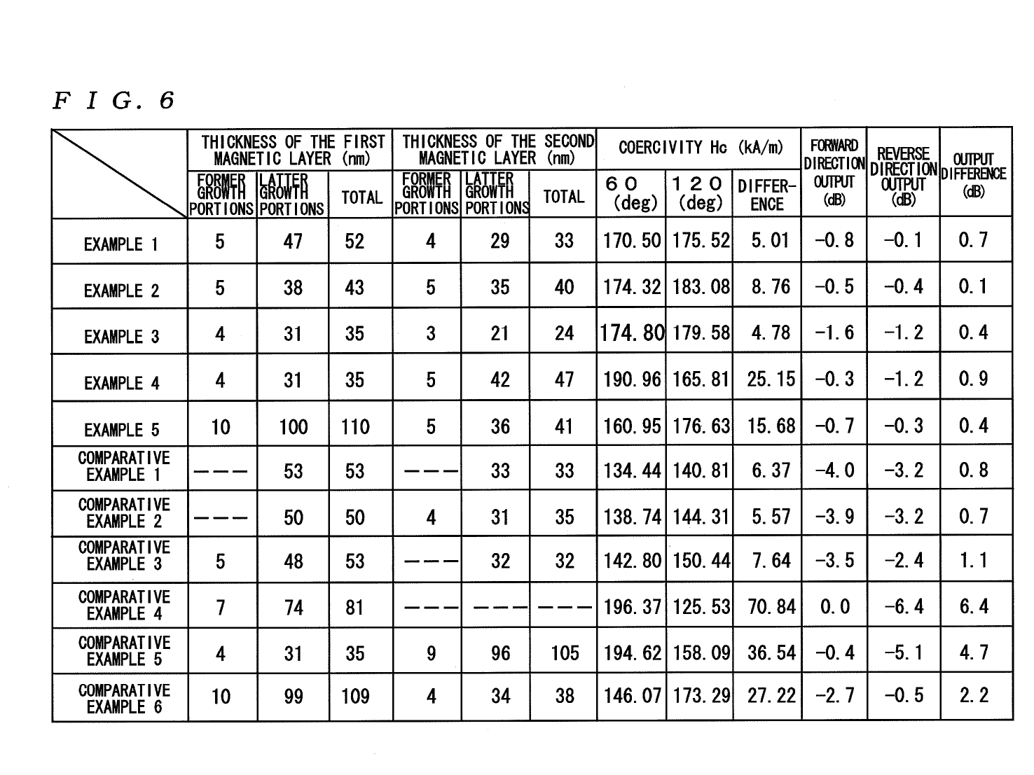

First, magnetic tapes T of Examples 1 to 5 and magnetic tapes of Comparative Examples 1 to 6 shown in FIG. 6 were manufactured using the manufacturing apparatus 10 described above. Here, the method of manufacturing the respective magnetic tapes T was fundamentally the same as for the magnetic tape 1 described above.

### Example 1

The first magnetic layer and the second magnetic layer were formed on the non-magnetic substrate 2 in the mentioned order so that the thickness of the former growth portions of the first magnetic layer was 5 nm, the thickness of the latter growth portions of the first magnetic layer was 47 nm, the thickness of the former growth portions of the second magnetic layer was 4 nm, and the thickness of the latter growth portions of the second magnetic layer was 29 nm. As a result, the thickness of the first magnetic layer was 52 nm and the thickness of the second magnetic layer was 33 nm.

### Example 2

### Magnetic Tape 1 Described Earlier

The first magnetic layer and the second magnetic layer were formed on the non-magnetic substrate 2 in the mentioned order so that the thickness of the former growth portions of the first magnetic layer was 5 nm, the thickness of the latter growth portions of the first magnetic layer was 38 nm, the thickness of the former growth portions of the second magnetic layer was 5 nm, and the thickness of the latter growth portions of the second magnetic layer was 35 nm. As a result, the thickness of the first magnetic layer was 43 nm and the thickness of the second magnetic layer was 40 nm.

### Example 3

The first magnetic layer and the second magnetic layer were formed on the non-magnetic substrate 2 in the mentioned order so that the thickness of the former growth portions of the first magnetic layer was 4 nm, the thickness of the latter growth portions of the first magnetic layer was 31 nm, the thickness of the former growth portions of the second magnetic layer was 3 nm, and the thickness of the latter growth portions of the second magnetic layer was 21 nm. As a result, the thickness of the first magnetic layer was 35 nm and the thickness of the second magnetic layer was 24 nm.

### Example 4

The first magnetic layer and the second magnetic layer were formed on the non-magnetic substrate 2 in the mentioned order so that the thickness of the former growth portions of the first magnetic layer was 4 nm, the thickness of the latter growth portions of the first magnetic layer was 31 nm, the thickness of the former growth portions of the second magnetic layer was 5 nm, and the thickness of the latter growth portions of the second magnetic layer was 42 nm. As a result, the thickness of the first magnetic layer was 35 nm and the thickness of the second magnetic layer was 47 nm.

### Example 5

The first magnetic layer and the second magnetic layer were formed on the non-magnetic substrate 2 in the mentioned order so that the thickness of the former growth portions of the first magnetic layer was 10 nm, the thickness of the latter growth portions of the first magnetic layer was 100 nm, the thickness of the former growth portions of the second magnetic layer was 5 nm, and the thickness of the latter growth portions of the second magnetic layer was 36 nm. As a result, the thickness of the first magnetic layer was 110 nm and the thickness of the second magnetic layer was 41 nm.

### Comparative Example 1

### Conventional Magnetic Recording Medium with Two Magnetic Layers

Without forming former growth portions in the first magnetic layer, the first magnetic layer was formed of only latter growth portions with a thickness of 53 nm and without forming former growth portions in the second magnetic layer, the second magnetic layer was formed of only latter growth portions with a thickness of 33 nm.

### Comparative Example 2

Without forming former growth portions in the first magnetic layer, the first magnetic layer was formed of only latter growth portions with a thickness of 50 nm. The second magnetic layer was formed with a thickness of 35 nm by forming latter growth portions with a thickness of 31 nm on former growth portions with a thickness of 4 nm.

### Comparative Example 3

The first magnetic layer was formed with a thickness of 53 nm by forming latter growth portions with a thickness of 48 nm on former growth portions with a thickness of 5 nm and without forming former growth portions in the second magnetic layer, the second magnetic layer was formed of only latter growth portions with a thickness of 32 nm.

### Comparative Example 4

### Conventional Magnetic Recording Medium with a Single Magnetic Layer

A single magnetic layer (only the first magnetic layer) with a thickness of 81 nm was formed by forming latter growth portions with a thickness of 74 nm on former growth portions with a thickness of 7 nm.

### Comparative Example 5

The first magnetic layer and the second magnetic layer were formed on the non-magnetic substrate 2 in the mentioned order so that the thickness of the former growth portions of the first magnetic layer was 4 nm, the thickness of the latter growth portions of the first magnetic layer was 31 nm, the thickness of the former growth portions of the second magnetic layer was 9 nm, and the thickness of the latter growth portions of the second magnetic layer was 96 nm. As a result, the thickness of the first magnetic layer was 35 nm and the thickness of the second magnetic layer was 105 nm.

### Comparative Example 6

The first magnetic layer and the second magnetic layer were formed on the non-magnetic substrate 2 in the mentioned order so that the thickness of the former growth portions of the first magnetic layer was 10 nm, the thickness of the latter growth portions of the first magnetic layer was 99 nm, the thickness of the former growth portions of the second magnetic layer was 4 nm, and the thickness of the latter growth portions of the second magnetic layer was 34 nm. As a result, the thickness of the first magnetic layer was 109 nm and the thickness of the second magnetic layer was 38 nm.

Measurement of Coercivity

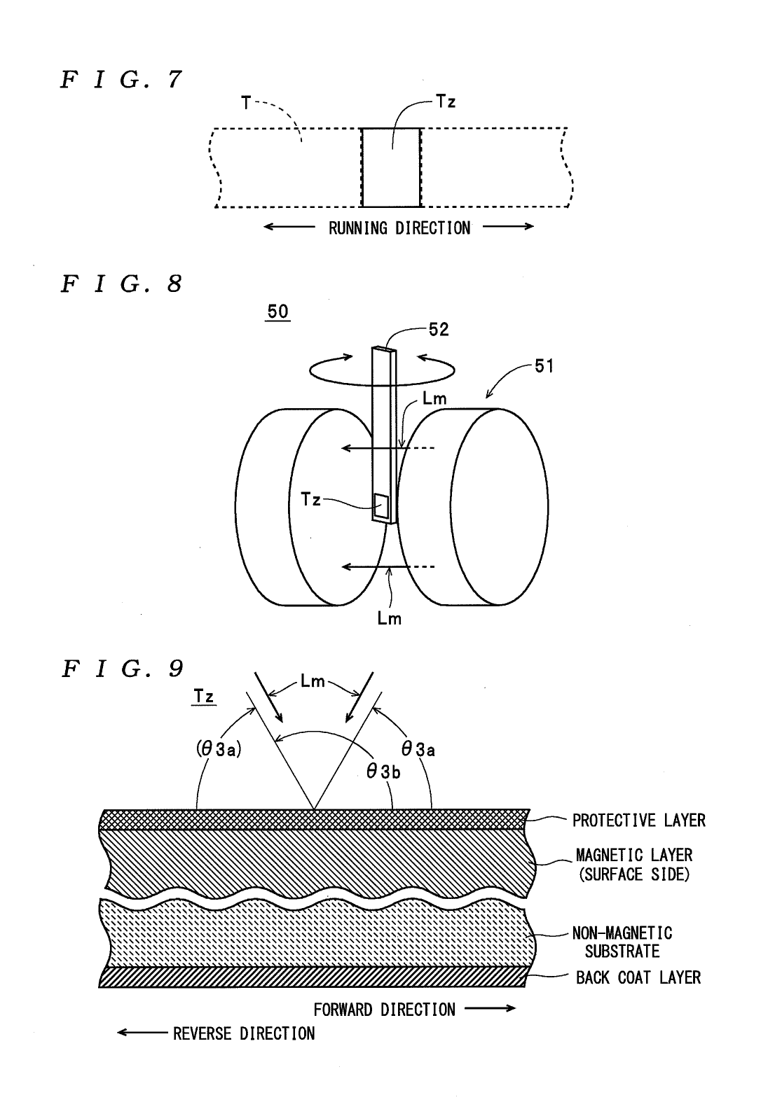

As shown in FIG. 7, samples Tz were fabricated by cutting up the respective magnetic tapes T that have been manufactured and the coercivity Hc was measured for the respective fabricated samples Tz in a state where various magnetic fields were applied using a VSM (Vibrating Sample Magnetometer) 50 shown in FIG. 8. The measurement results are shown in FIGS. 6, 10, and 11. Here, as shown in FIG. 8, the VSM 50 includes an electromagnet 51 and a control unit (measuring unit), not shown, and is constructed so as to generate a magnetic field using the electromagnet 51 and apply the magnetic field to a sample Tz in a state where the sample Tz has been attached to a sample attachment unit 52. The sample attachment unit 52 includes a vibrator, not shown, and is constructed so as to be capable of vibrating the sample Tz with a frequency of around 80 Hz, for example, and measuring the coercivity Hc (A/m) of the attached sample Tz. The VSM 50 is constructed so as to be capable of changing the angles of intersection θ3a, θ3b (see FIG. 9) between the plane of the non-magnetic substrate 2 of the sample Tz and the magnetic field lines Lm by rotating the electromagnet 51 relative to the sample attachment unit 52.

In the present specification, the magnetic tape is said to be running in the “forward direction” when the recording/reproducing head moves relative to the tape in the direction in which the non-magnetic substrate runs during the formation process of the second magnetic layer (the magnetic layer on the surface side) or during the formation process of a single magnetic layer, and the magnetic tape is said to be running in the “reverse direction” when the recording/reproducing head moves relative to the tape in the direction in which the non-magnetic substrate runs during the formation process of the first magnetic layer (the magnetic layer on the non-magnetic substrate 2 side). Also, as shown in FIG. 9, an angle that is inclined to a normal (i.e., the thickness direction) of the non-magnetic substrate 2 by 30° toward the forward direction is expressed by the phrase “the angle of intersection θ3a between the plane of the non-magnetic substrate and the magnetic field lines is 60°”. Also, an angle that is inclined to a normal to the non-magnetic substrate 2 by 30° toward the reverse direction is expressed by the phrase “the angle of intersection θ3b between the plane of the non-magnetic substrate and the magnetic field lines is 120° (60° when measured from the opposite side)”. Using the VSM 50, in this example, the angle of intersection described above was changed in steps of 5° and the coercivity Hc was measured for each step.

Measurement of Output

The signal level of the output signal when the tape was running in the forward direction and the signal level of the output signal when the tape was running in the reverse direction were measured for each of the magnetic tapes T described above. More specifically, recording was carried out at a recording wavelength of 0.4 μm using a drum tester on which a 0.16 μm-gap inductive head was mounted, reproducing was carried out using an AMR head, and the signal level (dB) of the output signal during reproducing was measured. The measurement results are shown in FIG. 6. Note that in the values of the “forward direction output (dB)” and the “reverse direction output (dB)”, the forward direction output (dB) of Comparative Example 4 is expressed as 0 dB. Also, the values of the “output difference (dB)” are expressed as absolute values of the difference between the output (dB) measured when the tape was running in the forward direction and the output (dB) measured when the tape was running in the reverse direction.

As shown in FIG. 6, for the magnetic tape T of Comparative Example 4 where only the first magnetic layer 3 is formed on the non-magnetic substrate 2 without the second magnetic layer 4 being formed, the signal level (dB) of the output signal when the tape was running in the reverse direction is 6.4 dB smaller than the signal level (dB) of the output signal when the tape was running in the forward direction. It is therefore believed that it will be extremely difficult to carry out bidirectional recording and reproducing on the magnetic tape T of Comparative Example 4.

For the magnetic tape T of Comparative Example 4, as shown by the solid line L4b in FIG. 11, the coercivity Hc measured in a state where a magnetic field is applied with an angle of intersection θ of around 120° between the plane of the non-magnetic substrate 2 and the magnetic field lines Lm is much lower than the coercivity Hc measured for other angles in the range of the angle of intersection. More specifically, although the coercivity Hc measured when the angle of intersection θ is 120° falls well below 160 kA/m for the magnetic tape T of Comparative Example 4, the coercivity Hc measured for other angles in the range of the angle of intersection is approximately 160 kA/m or higher.

On the other hand, with the magnetic tape T of Comparative Example 1 where two magnetic layers are formed so that the respective magnetization easy axes are inclined in opposite directions, the difference between the signal level (dB) of the output signal when the tape runs in the forward direction and the signal level (dB) of the output signal when the tape runs in the reverse direction is 0.8 dB. However, with the magnetic tape T of Comparative Example 1, the signal levels (dB) of the output signals when the tape runs in the forward direction and the reverse direction are both at least 3.2 dB lower than the signal level (dB) of the output signal of the magnetic tape T of Comparative Example 4 described above when the tape runs in the forward direction. This means that with the magnetic tape T of Comparative Example 1, there is the risk that a sufficient S/N ratio will not be obtained, which would result in deterioration in the error rate.

In this case, with the magnetic tape T of Comparative Example 1, as shown by the solid line L1b in FIG. 11, the coercivity Hc measured in a state where a magnetic field is applied with an angle of intersection θ of around 120° between the plane of the non-magnetic substrate 2 and the magnetic field lines Lm (i.e., the angle of intersection θ for which a large drop occurs in the coercivity Hc of the magnetic tape T of Comparative Example 4 described above) is 140 kA/m. On the other hand, with the magnetic tape T of Comparative Example 1, the coercivity Hc measured in a state where the magnetic field is applied with an angle of intersection θ for the magnetic field lines Lm of around 60° greatly falls to 130 kA/m or just over.

Also, with the magnetic tapes T of Comparative Examples 2, 3 where former growth portions are formed in one of the first magnetic layer 3 and the second magnetic layer 4, the differences between the signal level (dB) of the output signal when the tape runs in the forward direction and the signal level (dB) of the output signal when the tape runs in the reverse direction are respectively 0.7 dB and 1.1 dB. However, with the magnetic tapes T of both Comparative Examples 2 and 3, the signal levels (dB) of the output signals when the tape runs in both the forward direction and the reverse direction are both at least 2.4 dB lower than the signal level (dB) of the output signal when the magnetic tape T of Comparative Example 4 described above runs in the forward direction. This means that with the magnetic tapes T of Comparative Examples 2 and 3, in the same way as with the magnetic tape T of Comparative Example 1 described above, there is the risk that a sufficient S/N ratio will not be obtained, which would result in deterioration in the error rate.

Here, with the magnetic tapes T of Comparative Examples 2 and 3, as shown by the dot-dash line L2b and the dot-dot-dash line L3b in FIG. 11, the coercivity Hc measured in a state where the magnetic field is applied with an angle of intersection θ of around 120° between the plane of the non-magnetic substrate 2 and the magnetic field lines Lm (i.e., the angle of intersection θ where there is a large fall in the coercivity Hc of the magnetic tape T of Comparative Example 4 described above) is a quite high value in the same way as with the magnetic tape T of Comparative Example 1. On the other hand, with the magnetic tapes T of Comparative Examples 2 and 3, the coercivity Hc measured in a state where the magnetic field is applied with an angle of intersection θ of around 60° for the magnetic field lines Lm greatly falls in the same way as with the magnetic tape T of Comparative Example 1.

In addition, with the magnetic tapes T of Comparative Examples 5 and 6 where former growth portions are formed in both the first magnetic layer 3 and the second magnetic layer 4, due to the large difference between the thickness of the first magnetic layer 3 and the thickness of the second magnetic layer 4, the respective differences between the signal level (dB) of the output signal when the tape is running in the forward direction and the signal level (dB) of the output signal when the tape is running in the reverse direction are extremely large at 4.7 dB and 2.2 dB. This means that in the same way as the magnetic tape T of Comparative Example 4 described above, it is believed that bidirectional recording and reproducing of the magnetic tapes T of Comparative Examples 5 and 6 will be extremely difficult.

Here, with the magnetic tape T of Comparative Example 5, as shown by the dashed line L5b in FIG. 11, the coercivity Hc measured in a state where the magnetic field is applied with an angle of intersection θ of around 60° between the plane of the non-magnetic substrate 2 and the magnetic field lines Lm (i.e., the angle of intersection θ where there is a large fall in the coercivity Hc of the magnetic tapes T of Comparative Examples 1 to 3 described above) is quite high in the same way as with the magnetic tape T of Comparative Example 4. On the other hand, with the magnetic tape T of Comparative Example 5, the coercivity Hc measured in a state where the magnetic field is applied with an angle of intersection θ of around 1200 (i.e., the angle of intersection θ where there is a large fall in the coercivity Hc of the magnetic tape T of Comparative Example 4 described above) greatly falls in the same way as with the magnetic tape T of Comparative Example 4. Also, as shown by the dashed line L6b in FIG. 11, with the magnetic tape T of Comparative Example 6, the coercivity Hc measured in a state where the magnetic field is applied with an angle of intersection θ of around 120° (i.e., the angle of intersection θ where there is a large fall in the coercivity Hc of the magnetic tape T of Comparative Example 4 described above) is a sufficiently high value that exceeds 160 kA/m. On the other hand, with the magnetic tape T of Comparative Example 6, the coercivity Hc measured in a state where the magnetic field is applied with an angle of intersection θ of around 60° (i.e., the angle of intersection θ where there is a large fall in the coercivity Hc of the magnetic tapes T of Comparative Examples 1 to 3 described above) greatly falls compared to the coercivity measured for other angles in the range of the angle of intersection θ.

On the other hand, with the magnetic tapes T of Examples 1 to 3 where the former growth portions are formed in both the first magnetic layer 3 and the second magnetic layer 4 and the thicknesses of the first magnetic layer 3 and the second magnetic layer 4 are substantially equal, the respective differences between the signal level (dB) of the output signal when the tape is running in the forward direction and the signal level (dB) of the output signal when the tape is running in the reverse direction are small at 0.7 dB, 0.1 dB, and 0.4 dB. Also, with the magnetic tapes T of Examples 1 to 3, the signal levels (dB) of the output signals when the tape is running in the forward direction and in the reverse direction are only slightly lower than the signal level (dB) of the output signal of the magnetic tape T of Comparative Example 4 when the tape is running in the forward direction and even with the magnetic tape T of Example 3 that has the lowest output value, the output value in the forward direction is only −1.6 dB lower than the signal level (dB) of the output signal of the magnetic tape T of Comparative Example 4 when the tape is running in the forward direction, which means that an output signals of extremely high values are obtained for all of Examples 1 to 3.

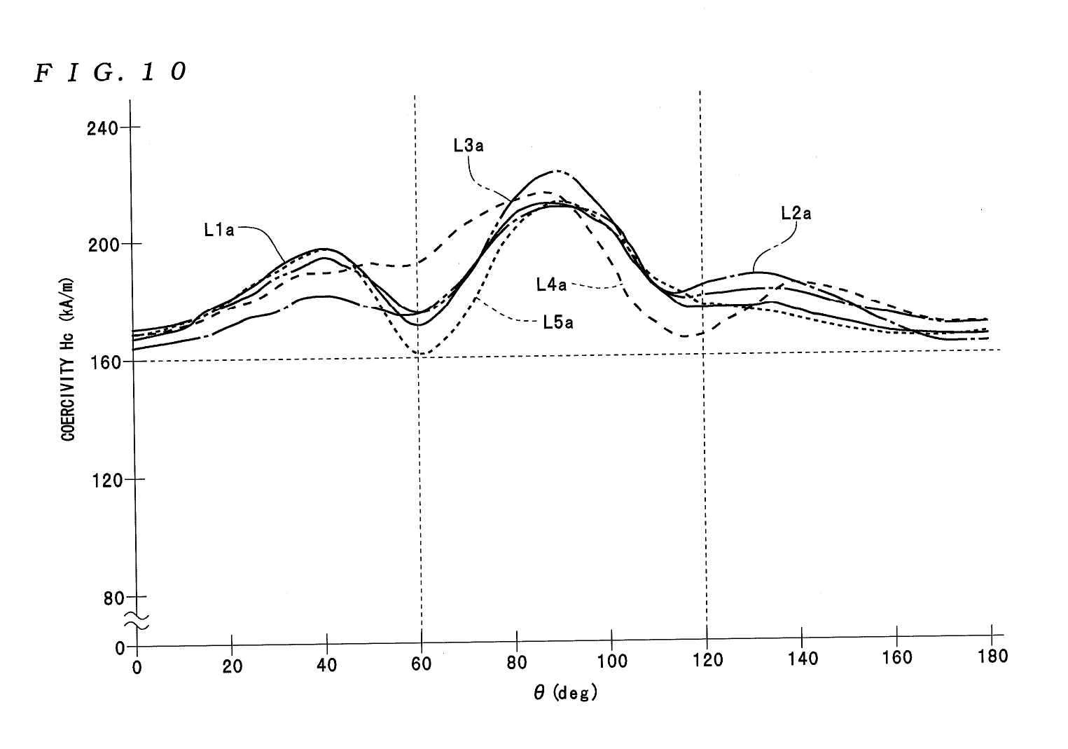

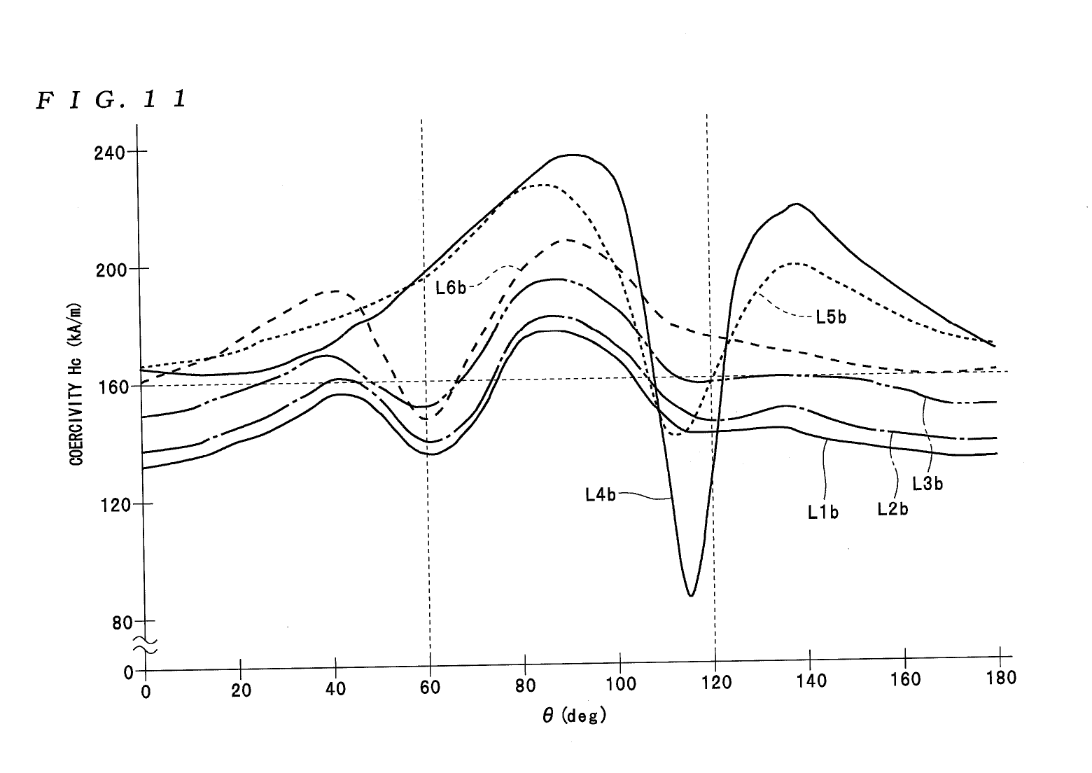

Here, with the magnetic tapes T of Examples 1 to 3, as shown by the solid line L1a, the dot-dash line L2a, and the dot-dot-dash line L3a in FIG. 10, the coercivity Hc measured in a state where the magnetic field is applied with an angle of intersection θ of around 60° between the plane of the non-magnetic substrate 2 and the magnetic field lines Lm (i.e., the angle of intersection θ where there is a large fall in the coercivity Hc of the magnetic tapes T of Comparative Examples 1 to 3 described above) and the coercivity Hc measured in a state where the magnetic field is applied with an angle of intersection 9 of around 120° (i.e., the angle of intersection θ where there is a large fall in the coercivity Hc of the magnetic tape T of Comparative Example 4 described above) are both high values that exceed 170 kA/m and the values of the coercivity Hc measured for all other angles in the range of the angle of intersection θ are all at least 160 kA/m.

Also, with the magnetic tapes T of Examples 4 and 5 where former growth portions are formed in both the first magnetic layer 3 and the second magnetic layer 4, like the magnetic tapes T of the Examples 1 to 3 described above, the respective differences between the signal level (dB) of the output signal when the tape is running in the forward direction and the signal level (dB) of the output signal when the tape is running in the reverse direction are both sufficiently small at 0.9 dB and 0.4 dB. In addition, with the magnetic tapes T of Examples 4 and 5, the signal levels (dB) of the output signals when the tape is running in both the forward direction and the reverse direction are both only slightly smaller than the signal level (dB) of the output signal for the magnetic tape T of Comparative Example 4 described above when the tape is running in the forward direction, which means that output signals with extremely high signal level are obtained.

Here, with the magnetic tape T of Example 4, as shown by the dashed line L4a in FIG. 10, although the coercivity Hc measured in a state where the magnetic field is applied with an angle of intersection θ of around 120° between the plane of the non-magnetic substrate 2 and the magnetic field lines Lm (i.e., the angle of intersection θ where there is a large fall in the coercivity Hc of the magnetic tape T of Comparative Example 4 described above) is slightly low at around 165 kA/m, the coercivity Hc measured in a state where the magnetic field is applied with an angle of intersection θ of around 60° (i.e., the angle of intersection θ where there is a large fall in the coercivity Hc of the magnetic tapes T of Comparative Examples 1 to 3 described above) is extremely high at 190 kA/m, and the values of the coercivity Hc measured for other angles of intersection θ are all at least 160 kA/m.

Here, with the magnetic tape T of Example 5, as shown by the dashed line L5a in FIG. 10, although the coercivity Hc measured in a state where the magnetic field is applied with an angle of intersection θ of around 600 between the plane of the non-magnetic substrate 2 and the magnetic field lines Lm (i.e., the angle of intersection θ where there is a large fall in the coercivity Hc of the magnetic tapes T of Comparative Examples 1 to 3 described above) is slightly low at around 160 kA/m, the coercivity Hc measured in a state where the magnetic field is applied with an angle of intersection θ of around 120° (i.e., the angle of intersection θ where there is a large fall in the coercivity Hc of the magnetic tape T of Comparative Example 4 described above) is high at around 176 kA/m, and the values of the coercivity Hc measured for other angles of intersection θ are all at least 160 kA/m.

In this way, for the magnetic tapes T of Comparative Examples 3 to 6 where one or both of the coercivity Hc measured in a state where a magnetic field is applied with an angle of intersection θ of 60° between the plane of the non-magnetic substrate 2 and the magnetic field lines Lm and the coercivity Hc measured with an angle of intersection θ of 120° is/are below 160 kA/m, there is a large difference between the signal level (dB) of the output signal when the tape is running in the forward direction and the signal level (dB) of the output signal when the tape is running in the reverse direction of at least 1.1 dB. On the other hand, for the magnetic tapes T of Examples 1 to 5 where both the coercivity Hc measured in a state where a magnetic field is applied with an angle of intersection θ of 60° between the plane of the non-magnetic substrate 2 and the magnetic field lines Lm and the coercivity Hc measured with an angle of intersection θ of 120° are at least 160 kA/m, the difference between the signal level (dB) of the output signal when the tape is running in the forward direction and the signal level (dB) of the output signal when the tape is running in the reverse direction is sufficiently small at 1.0 dB or below (in this example, 0.9 dB or below).

Accordingly, by forming the first magnetic layer 3 and the second magnetic layer 4 so that the coercivity Hc measured when the angle of intersection θ is 60° and the coercivity Hc measured when the angle of intersection θ is 120° are both at least 160 kA/m, it is possible to sufficiently suppress the difference in the signal levels of the output signals when the tape is running in the forward direction and in the reverse direction. As a result, it can be understood that it is possible to manufacture magnetic tapes that are suited to bidirectional recording and reproducing. With the magnetic tapes T of Comparative Examples 1 and 2, although the difference in the signal levels of the output signals when the tape is running in the forward direction and in the reverse direction is small at 1.0 dB or below (in this example, 0.8 dB or below), the signal levels of the output signals are low when the tape is running in both the forward direction and the reverse direction. This means that there is the risk of deterioration in the error rate. With the magnetic tapes T of Comparative Examples 1 and 2, although the coercivity Hc is quite high when the angle of intersection θ is around 90°, the coercivity Hc for all other angles in the range of the angle of intersection θ is extremely low at 160 kA/m or below.

Here, with the magnetic tapes T of Examples 1 to 3 and 5 where the coercivity Hc measured when the angle of intersection θ between the plane of the non-magnetic substrate 2 and the magnetic field lines Lm is 120° is larger than the coercivity Hc measured when the angle of intersection θ is 60°, the difference between the signal level (dB) of the output signal when the tape is running in the forward direction and the signal level (dB) of the output signal when the tape is running in the reverse direction is extremely small at 0.7 dB or below. On the other hand, with the magnetic tape T of Example 4 where the coercivity Hc measured when the angle of intersection θ is 120° is lower than the coercivity Hc measured when the angle of intersection θ is 60°, the difference between the signal level (dB) of the output signal when the tape is running in the forward direction and the signal level (dB) of the output signal when the tape is running in the reverse direction is quite large at 0.9 dB. Accordingly, it can be understood that by forming the first magnetic layer 3 and the second magnetic layer 4 so that the coercivity Hc measured when the angle of intersection θ is 120° is higher than the coercivity Hc measured when the angle of intersection θ is 60°, the difference between the signal levels of the output signals when the tape is running in the forward direction and in the reverse direction can be suppressed to a significantly smaller value.

In this way, according to the magnetic tape 1, by forming the first magnetic layer 3 and the second magnetic layer 4 (“metal thin-film magnetic layers”) so that the coercivity measured in a state where a magnetic field is applied with an angle of intersection of around 60° between the plane of the non-magnetic substrate 2 and the magnetic field lines Lm and the coercivity measured in a state where the magnetic field is applied with an angle of intersection of around 120° are both at least 160 kA/m, it is possible to make the signal levels of the output signals from the magnetic head substantially equal when the tape is running in both the forward direction and the reverse direction during bidirectional recording and reproducing. In addition, a sufficiently high coercivity (in this example, at least 160 kA/m) can be obtained regardless of the angle of intersection between the plane of the non-magnetic substrate 2 and the magnetic field lines Lm. Accordingly, recording/reproducing control is simplified corresponding to the ability to reproduce recorded data without a large difference in the recording/reproducing conditions between when the tape is running forwards and when the tape is running in reverse, which makes it possible to sufficiently reduce the manufacturing cost of a recording/reproducing apparatus. It is also possible to maintain a sufficient magnetization state for recorded data to be read properly even when the width of the data recording tracks is reduced and/or the length of one bit on each data recording track is reduced to increase the recording density (a state where the influence of adjacent bits in the track width direction and the track length direction becomes prominent). By doing so, it is possible to obtain a sufficiently high S/N ratio, and as a result a magnetic tape 1 with a favorable error rate can be provided.

Also, according to the magnetic tape 1, by forming the first magnetic layer 3 and the second magnetic layer 4 (“metal thin-film magnetic layers”) so that the coercivity measured in a state where a magnetic field is applied with the angle of intersection of 120° described above is higher than the coercivity measured in a state where the magnetic field is applied with the angle of intersection of 60°, the difference between the signal level of the output signal when the tape is running forwards and the signal level of the output signal when the tape is running in reverse can be suppressed to a significantly smaller value. Accordingly, the recording/reproducing conditions when the tape is running forwards and when the tape is running in reverse can be set substantially the same.

What is claimed is:

1. A magnetic recording medium comprising a metal thin-film magnetic layer formed on a non-magnetic substrate, wherein the metal thin-film magnetic layer is formed so that a coercivity measured when a magnetic field is applied with an angle of intersection of 60° between a plane of the non-magnetic substrate and magnetic field lines of the magnetic field and the coercivity measured when the magnetic field is applied with the angle of intersection of 120° are both at least 160 kA/m.

2. A magnetic recording medium according to claim 1, wherein the metal thin-film magnetic layer is formed so that the coercivity measured when the magnetic field is applied with the angle of intersection of 120° is higher than the coercivity measured when the magnetic field is applied with the angle of intersection of 60°.

3. A magnetic recording medium according to claim 1, wherein:
a first magnetic layer and a second magnetic layer are formed as the metal thin-film magnetic layer in the mentioned order on the non-magnetic substrate so that a ratio of a thickness of the first magnetic layer to a thickness of the second magnetic layer is in a range of 0.60 to 2.10, inclusive; and
the first magnetic layer and the second magnetic layer are comprised of former growth portions and latter growth portions formed on the former growth portions.

4. A magnetic recording medium according to claim 2, wherein:
a first magnetic layer and a second magnetic layer are formed as the metal thin-film magnetic layer in the mentioned order on the non-magnetic substrate so that a ratio of a thickness of the first magnetic layer to a thickness of the second magnetic layer is in a range of 0.60 to 2.10, inclusive; and
the first magnetic layer and the second magnetic layer are comprised of former growth portions and latter growth portions formed on the former growth portions.
